(19) United States
(12) Patent Application Publication
(10) Pub. No.: US 2025/0266623 A1
(43) Pub. Date: Aug. 21, 2025

(54) MULTIPOLARIZED PATCH ANTENNA ARRAY

(71) Applicants: RFIDKNOW LLC, Simpsonville, SC (US); INNOVOI OY / LTD, Siuro (FI)

(72) Inventors: Jeffrey Joseph Hoerl, JR., Simpsonville, SC (US); Matti Ritamäki, Siuro (FI)

(21) Appl. No.: 19/056,657

(22) Filed: Feb. 18, 2025

Related U.S. Application Data
(60) Provisional application No. 63/554,219, filed on Feb. 16, 2024.

(51) Int. Cl. H01Q 21/06; H01Q 1/22; H01Q 9/04

(52) U.S. Cl. CPC H01Q 21/065; H01Q 1/2208; H01Q 9/0407

(57) ABSTRACT

An antenna array for use in RFID reader applications is provided. The antenna array may include a plurality of patch antenna elements, a plurality of microstrip connection elements, a probe feed, a ground layer, and an isolation layer. The plurality of patch antenna elements may form multipolarized patch antenna array, and each microstrip connection element may connect two patch antenna elements. The probe feed may be configured to provide a feed point to the antenna array via a galvanic isolated connection to a feed patch antenna element that is one of the plurality of patch antenna elements. The isolation layer may be disposed between the plurality of patch antenna elements and the ground layer.

### CROSS-REFERENCE TO RELATED APPLICATIONS

This application claims the benefit of U.S. Provisional Application No. 63/554,219 filed on Feb. 16, 2024, the entire contents of which are hereby incorporated herein by reference.

### TECHNICAL FIELD

Example embodiments generally relate to wireless communications technology and, in particular antenna technology for RFID tag readers.

### BACKGROUND

An radio frequency identification (RFID) tag is often a passive communications device that is excited by an interrogation field and configured to respond to the interrogation field with a signal comprising information, such as a unique identifier for the tag. To interact with the RFID tags, a reader device may include one or more antenna configured to wireless communicate and interact with the RFID tags.

However, the operational frequencies and environments of operation are not always conducive to reliable communications between tags and readers. For example, in some instances, merely changing in the orientation of the tag antenna relative to the reader antenna can result in the communication failures. Additionally, some reader antennas are not well-suited for near-field reads. For example, when a tag is very close to the reader antenna, e.g., within six inches of the reader antenna, the reader antenna may have difficulties interacting with the tag to perform a tag read due to the field characteristic in close proximity to the reader antenna. On the other hand, in some instances, reader antennas can also have a technical problem with stray reads that, for example, involve reading a tag that is not in read region. Such stray reads can lead to miscounts and loss of data integrity since a tag that should not have been read is now counted in, for example, inventory or the like.

Additionally, conventional reader antennas can involve numerous solder connections and careful assembly to ensure that such connections are robust. Poor solder connections within the reader antenna can not only lead to mechanical failure of the connection, but, in some instances, a mechanical failure is not apparent, but a poor electrical connection is present. In some environments, the solder connections can corrode and oxidize, which mechanically and electrically weaken the connection. In such situations, the impedance of the antenna circuitry can be affected by the poor connection, which can cause antenna operation to be poor and unreliable.

### BRIEF SUMMARY OF SOME EXAMPLES

According to some example embodiments, an antenna array is provided. The antenna array may comprise a plurality of patch antenna elements, a plurality of microstrip connection elements, a probe feed, a ground layer, and an isolation layer. The plurality of patch antenna elements may form multipolarized patch antenna array, and each microstrip connection element may connect two patch antenna elements. The probe feed may be configured to provide a feed point to the antenna array via a galvanic isolated connection to a feed patch antenna element that is one of the plurality of patch antenna elements. The isolation layer may be disposed between the plurality of patch antenna elements and the ground layer.

According to some example embodiments, a tag reader portal is provided. The tag reader portal may comprise a rigid structure, a reader controller, and a plurality of antenna array assemblies. The rigid structure may form a portal passage, and the plurality of antenna array assemblies may be supported by the rigid structure around the portal passage to generate a multipolarized read field within the portal passage. The reader controller may be connected to each of the antenna array assemblies to control the antenna array assemblies and receive tag reader information from the antenna array assemblies. The plurality of antenna array assemblies may comprise an antenna array assembly. The antenna array assembly may comprise a plurality of patch antenna elements, a plurality of microstrip connection elements, a probe feed, a ground layer, and an isolation layer. The plurality of patch antenna element may form multipolarized patch antenna array, and each microstrip connection element may connect two patch antenna elements. The probe feed may be configured to provide a feed point to the antenna array via a galvanic isolated connection to a feed patch antenna element that is one of the plurality of patch antenna elements. The isolation layer may be disposed between the plurality of patch antenna elements and the ground layer.

### BRIEF DESCRIPTION OF THE SEVERAL VIEWS OF THE DRAWING(S)

Having thus described some embodiments in general terms, reference will now be made to the accompanying drawings, which are not necessarily drawn to scale, and wherein:

FIG. 1 illustrates tag reader portal according to some example embodiments;

FIG. 2 illustrates block diagram of a reader controller according to some example embodiments;

FIG. 3A illustrates a structural block diagram of a multipolarized patch antenna array according to some example embodiments;

FIG. 3B illustrates a cross-section side view of the multipolarized patch antenna array of FIG. 3A according to some example embodiments;

FIG. 3C illustrates a graph of a field patter of patch antenna element according to some example embodiments;

FIG. 4A illustrates a multipolarized patch antenna array according to some example embodiments;

FIG. 4B illustrates a cross-section side view of the multipolarized patch antenna array of FIG. 4A according to some example embodiments;

FIG. 5A illustrates a multipolarized patch antenna array according to some example embodiments;

FIG. 5B illustrates a cross-section side view of the multipolarized patch antenna array of FIG. 5A according to some example embodiments;

FIG. 6A illustrates a multipolarized patch antenna array according to some example embodiments;

FIG. 6B illustrates a cross-section side view of the multipolarized patch antenna array of FIG. 6A according to some example embodiments;

FIG. 7A illustrates a multipolarized patch antenna array according to some example embodiments;

FIG. 7B illustrates a cross-section side view of the multipolarized patch antenna array of FIG. 7A according to some example embodiments;

FIG. 8A illustrates a multipolarized patch antenna array according to some example embodiments;

FIG. 8B illustrates a cross-section side view of the multipolarized patch antenna array of FIG. 8A according to some example embodiments;

FIG. 9 illustrates an assembly of patch antenna elements and feed lines according to some example embodiments;

FIG. 10 illustrates an assembly of patch antenna elements and feed lines according to some example embodiments;

FIG. 11 illustrates field vectors for an antenna array according to some example embodiments;

FIGS. 12, 14, 16, and 18 illustrate an antenna array with a tag is various respective movement directions and orientations according to some example embodiments; and

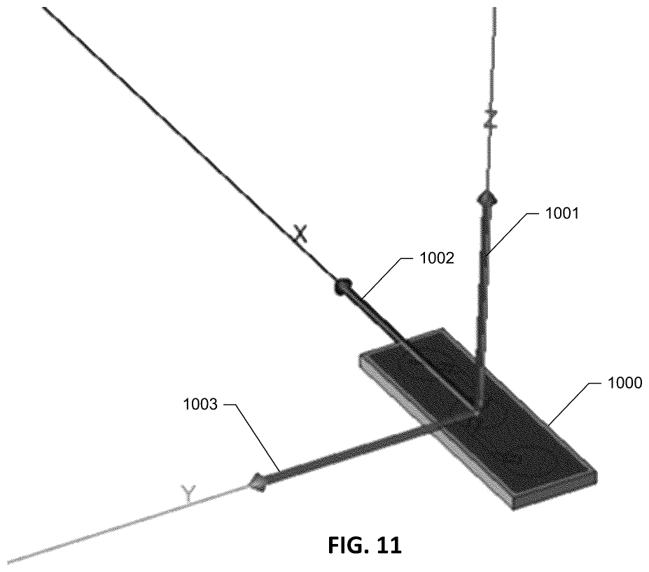

FIGS. 11, 15, 17, and 19 provide respective graphs of power transfer curves for the tag movements and orientations according to some example embodiments.

### DETAILED DESCRIPTION

Some example embodiments now will be described more fully hereinafter with reference to the accompanying drawings, in which some, but not all example embodiments are shown. The examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout.

Following from the background above, some example embodiments of systems, apparatuses, and methods are described that are associated with a high-performance multipolarized antenna array and assembly for use in a variety of RFID reader applications, including, but not limited to, a tag reader portal. According to some example embodiments, the technical problems of antenna communications reliability due to changing orientations of RFID tag antenna are addressed. Moreover, according to some example embodiments, antenna arrays described herein may be manufactured in a relatively simple manner, at least partially due a probe feed of the antenna array having a non-mechanical galvanic isolated connection to a feed patch antenna element, rather than a soldered connection that may suffer from the issues described above.

As such, according to some example embodiments, antenna arrays are described herein provide a technical solution to the technical problems and challenges mentioned above, as well as other technical problems and challenges. An example antenna array may comprise a plurality of patch antenna elements, a plurality of microstrip connection elements, a probe feed, a ground layer, and an isolation layer. The plurality of patch antenna elements may form multipolarized patch antenna array, and each microstrip connection element may connect two patch antenna elements. The probe feed may be configured to provide a feed point to the antenna array via a galvanic isolated connection to a feed patch antenna element that is one of the plurality of patch antenna elements. The isolation layer may be disposed between the plurality of patch antenna elements and the ground layer.

As further described below, various configurations of the plurality of patch antenna elements, including variations in shape, quantity, and connections. Also, the various configurations of probe feed connections are described that include both mechanical and non-mechanical inductive-type connections that do not include a mechanical connection of a conductor to form an electrical connection (e.g., galvanic isolated connections).

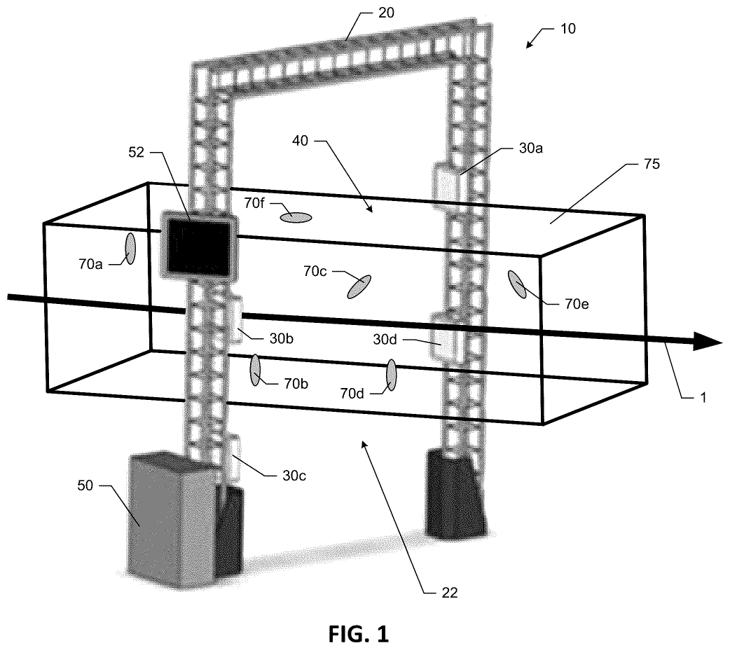

Now with reference to FIG. 1, a tag reader portal 10 is shown. The tag reader portal 10 may be positioned, for example, at an ingress or egress location of a building to be able to read tags (e.g., RFID tags) that are entering or leaving the building. In this regard, for example, the tag reader portal 10 may be positioned at a loading dock back door of a retail store to read the tags on product packaging (e.g., stacked on a pallet) that is being unloaded from a truck and delivered into a stock room of the retail store. In another example, the tag reader portal 10 may be positioned at an entry way of a delivery service that receives palletized packages with tags that have been bulk shipped to a local distribution center.

The tag reader portal 10 may therefor comprise a rigid structure 20, a plurality of antenna arrays 30a-30d that generate a read region 40, and a reader controller 50. The rigid structure 20 may be any type of structural element to which the antenna arrays 30a-30d can be affixed to support the antenna arrays 30a-30d. The rigid structure 20 of FIG. 1 is a lattice structure forming an upside-down U-shape. Within the U-shape, the rigid structure 20 defines a portal passage 22 through which physical objects may pass. According to some example embodiments, the rigid structure 20 need not be a separate stand-alone apparatus and could be, for example, a door frame of a loading dock door. In some example embodiments, the rigid structure 20 may be movable, such as in the form of a movable arm to which the antenna arrays 30a-30d may be affixed.

The tag reader portal 10 may include any number of antenna arrays. As an example, the tag reader portal 10 includes four antenna arrays 30a-30d. The antenna arrays 30a-30d are positioned on the sides of the rigid structure 20 at different heights. The positioning of the antenna arrays 30a-30d can form a read or interrogation region 40 within the portal passage 22. In this regard, since the fields generated by the antenna arrays 30a-30d may be constructive or destructive, the antenna arrays 30a-30d may be positioned to create a read region 40 that fills a volume of the portal passage 22 in order to read all tags that pass through the portal passage 22. As can be seen in FIG. 1, the antenna array 30c is positioned close to the floor on the left side of the rigid structure 20, the antenna array 30d is positioned on the right side of the rigid structure 20 at a height that is higher than the height of the antenna array 30c. The antenna array 30b is positioned on the left side of the rigid structure 20 at a height that is higher than the height of the antenna array 30d, and the antenna array 30a is positioned on the right side of the rigid structure 20 at a height that is higher than the height of the antenna array 30b. Although not shown, in accordance with some example embodiments, additional antenna arrays may be located, for example, on the top of the rigid structure 20 to generate a field in a generally downward direction. Further, according to some example embodiments, additional antenna arrays may be located in the floor to generate a field in a generally upward direction. As such, the number and positioning of the antenna arrays may be determined to generate a read region 40 that is highly likely or certain to read all tags that pass through the portal passage 22.

As shown in FIG. 1, an object 75 is passing through the portal passage 22 and the read region 40 in the direction 1. The object 75 may be, for example, a pallet of boxes or packages, where each box or package has a tag 70 (e.g., an RFID tag) affixed thereto. Since the boxes or packages may not be of uniform size and shape, the tags 70a-70e may be disposed in random locations on the object 75 and with different orientations. As shown in FIG. 1, the tags 70a-70e pass through the portal passage 22 and the read region 40 to be interacted with by the antenna arrays 30a-30d. Since the antenna arrays 30a-30d operate together to form a multipolarized field, the tag reader portal 10 may be capable of reading all of the tags 70a-70c, even though the tags are positioned and oriented randomly. The tag reader portal 10 may be one of many example implementations of a reader system that may take advantage of the benefits of the example embodiments of an antenna array as described herein.

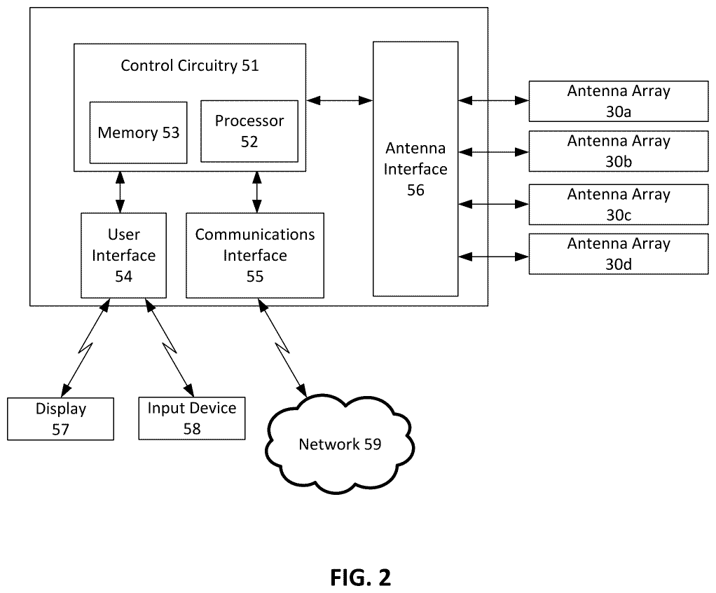

Now referring to FIG. 2, an example block diagram of the reader controller 50 is shown. In this regard, reader controller 50 comprises control circuitry 51. Control circuitry 51 may, in turn, comprise a processor 52, a memory 53, a user interface 54, and a communications interface 55. Additionally, the reader controller 50 may include additional components not shown in FIG. 2 and the control circuitry 51 may be operably coupled to other components of the reader controller 50 that are not shown in FIG. 2.

Further, according to some example embodiments, control circuitry 51 may be in operative communication with or embody, the memory 53, the processor 52, the user interface 54, and the communications interface 55. Through configuration and operation of the memory 53, the processor 52, the user interface 54, and the communications interface 55, the control circuitry 51 may be configurable to perform various operations of the reader controller 50 and control the operations of the tag reader portal 10 and the antenna arrays 30a-30d as described herein. In this regard, the control circuitry 51 may be configured to perform wireless communications operations, computational processing, memory management, user interface control and monitoring, and manage remote communications, according to an example embodiment. In some embodiments, the control circuitry 51 may be embodied as a chip or chip set. In other words, the control circuitry 51 may comprise one or more physical packages (e.g., chips) including materials, components or wires on a structural assembly (e.g., a baseboard). The control circuitry 51 may be configured to receive inputs (e.g., via peripheral components), perform actions based on the inputs, and generate outputs (e.g., for provision to peripheral components). In an example embodiment, the control circuitry 51 may include one or more instances of a processor 52, associated circuitry, and memory 53. As such, the control circuitry 51 may be embodied as a circuit chip (e.g., an integrated circuit chip, such as a field programmable gate array (FPGA)) configured (e.g., with hardware, software or a combination of hardware and software) to perform operations described herein.

In an example embodiment, the memory 53 may include one or more non-transitory memory devices such as, for example, volatile or non-volatile memory that may be either fixed or removable. The memory 53 may be configured to store information, data, applications, instructions or the like for enabling, for example, the functionalities described with respect to the tag reader portal 10 and the antenna arrays 30a-30d. The memory 53 may operate to buffer instructions and data during operation of the control circuitry 51 to support higher-level functionalities, and may also be configured to store instructions for execution by the control circuitry 51. The memory 53 may also store various information including tag read information and the like. According to some example embodiments, various data stored in the memory 53 may be generated based on other data and stored or the data may be retrieved via the communications interface 55 and stored in the memory 53.

As mentioned above, the control circuitry 51 may be embodied in a number of different ways. For example, the control circuitry 51 may be embodied as various processing means such as one or more processors 52 that may be in the form of a microprocessor or other processing element, a coprocessor, a controller or various other computing or processing devices including integrated circuits such as, for example, an ASIC (application specific integrated circuit), an FPGA, or the like. In an example embodiment, the control circuitry 51 may be configured to execute instructions stored in the memory 53 or otherwise accessible to the control circuitry 51. As such, whether configured by hardware or by a combination of hardware and software, the control circuitry 51 may represent an entity (e.g., physically embodied in circuitry-in the form of control circuitry 51) capable of performing operations according to example embodiments while configured accordingly. Thus, for example, when the control circuitry 51 is embodied as an ASIC, FPGA, or the like, the control circuitry 51 may be specifically configured hardware for conducting the operations described herein. Alternatively, as another example, when the control circuitry 51 is embodied as an executor of software instructions, the instructions may specifically configure the control circuitry 51 to perform the operations described herein.

The communications interface 55 may include one or more interface mechanisms for enabling communication with other devices external to the reader controller 50, via, for example, network 59, which may, for example, be a local area network, the Internet, or the like, through a direct (wired or wireless) communication link to another external device, or the like. In some cases, the communications interface 55 may be any means such as a device or circuitry embodied in either hardware, or a combination of hardware and software that is configured to receive or transmit data from/to a communications network, such as network 59. The communications interface 55 may be a wired or wireless interface and may support various communications protocols (WIFI, Bluetooth, cellular, or the like).

The user interface 54 may be controlled by the control circuitry 51 to interact with peripheral components or devices of the reader controller 50 that can receive inputs from a user or provide outputs to a user. In this regard, via the user interface 54, the control circuitry 51 may be configured to receive inputs from an input device 58. The display 57 may be one example of an input device 58, which may be a touch screen display. Other input devices 58 may also be used such as a keyboard, a mouse, a microphone, or the like. The user interface 54 may also be configured to provide control and outputs to peripheral devices such as, for example, the display 57, a speaker, or the like. The user interface 54 may also produce outputs, for example, as visual outputs on a display, audio outputs via a speaker, or the like.

The reader controller 50 may also include an antenna interface 56. The antenna interface 56 may be a separate interface component or integrated into the control circuitry 51. The antenna interface 56 may be configured to provide connectivity as, for example, a multiplexing device to connect the control circuitry 51 to any number of antenna arrays. In the example of FIG. 2, the antenna interface 56 is connected to the antenna arrays 30a-30d. Via the antenna interface 56, the control circuitry 51 may control both transmission and reception of the antenna arrays 30a-30d.

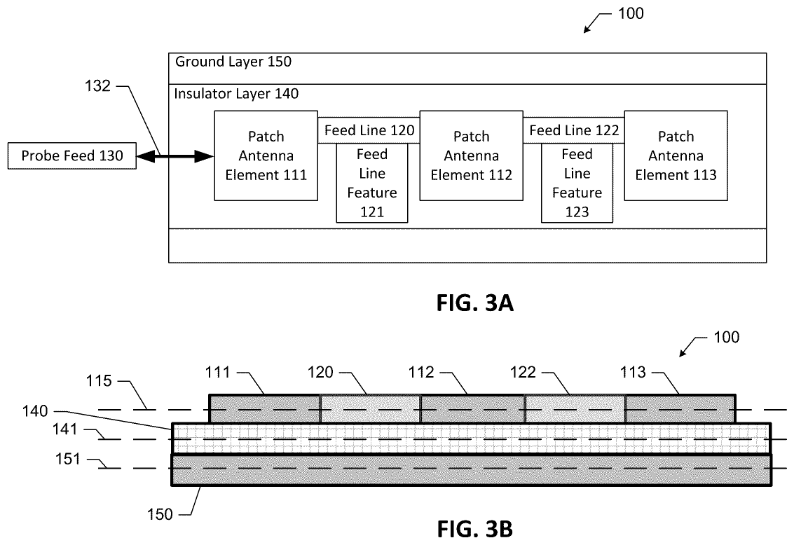

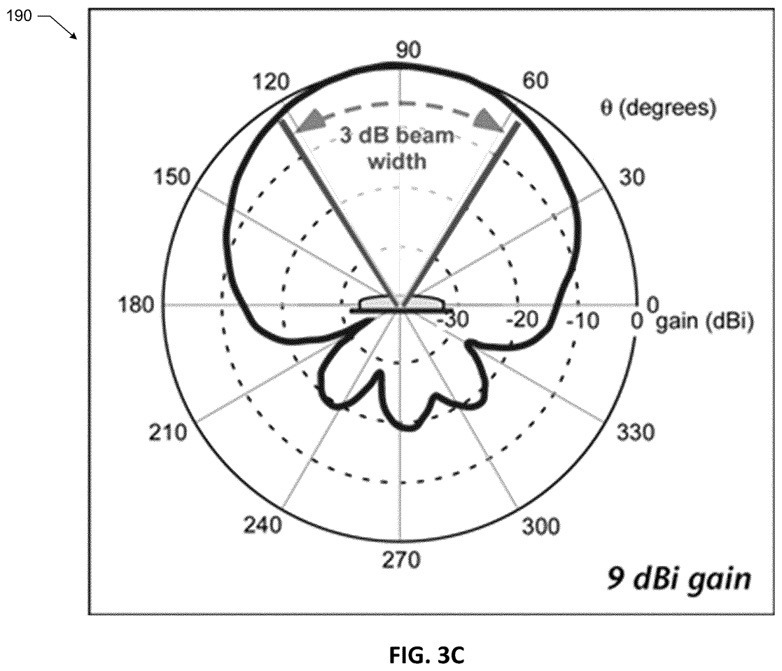

Various example embodiments of antenna arrays (also referred to as antenna array assemblies) and details associated with the same will now be described. FIG. 3A illustrates an example block diagram of the structure of an example antenna array 100 in according to some example embodiments. FIG. 3B illustrates a side cross-section view of the example antenna array 100 according to some example embodiments. The antenna array 100 may be an example of an antenna array that may be implemented as one of antenna arrays 30a-30d.

With reference to FIGS. 3A and 3B, the antenna array 100 may comprise a plurality of patch antenna elements (e.g., patch antenna elements 111, 112, and 113), a plurality of feed lines (e.g., feed lines 120 and 122), a probe feed 130 with a probe feed interface 132, an isolation layer 140, and a ground layer 150. As further described below, these elements, according to some example embodiments, may be assembled in a stacked fashion for ease of assembly with the plurality of patch antenna elements and the plurality of feed lines being disposed on a common layer and in a common plane, i.e., the patch plane 115. The isolation layer 140 may be a separate layer from the layer with the patch antenna elements and the plurality of feed lines and may be disposed in the isolation layer plane 141, which may be parallel to the patch plane 115. The ground layer 150 may be a separate layer from the isolation layer 140 and the layer with the patch antenna elements and the plurality of feed lines. The ground layer 150 may be disposed in a plane, i.e., the ground layer plane 151 that is at least parallel to the patch plane 115, according to some example embodiments. According to some example embodiments, each of the patch plane 115, the isolation layer plane 141, and the ground layer plane 151 may each be parallel planes or may include portions that extend in parallel planes.

According to some example embodiments, the antenna elements of the antenna array 100 may be patch antenna elements 111, 112, and 113. While any number of antenna elements may be included in the antenna array 100 in order to implement a desired read region, the antenna array 100 is shown as having three antenna elements connected in series via the feed lines. Note that the antenna elements may also be connected in any electrical configuration having series or parallel connections to obtain the desired field parameters.

The patch antenna elements 111, 112, and 113 may be conductive and have a small thickness relative to their width and length (e.g., 1 to 1000 ratio or more). Therefore, the patch antenna elements 111, 112, and 113 may have the appearance of a “patch.” According to some example embodiments, the patch antenna elements 111, 112, and 113 may be microstrip patch antenna elements. As such, patch antenna elements 111, 112, and 113 may have a very low profile relative to, for example, dipole antennas that may not be so compact to achieve similar performance. The patch antenna elements 111, 112, and 113 may be formed of any conductor, such as a metal. However, according to some example embodiments, since the patch antenna elements 111, 112, and 113 are not subjected to a physical or mechanical connection to the probe feed 130 (e.g., a solder connection), delicate and low-cost conductive materials such as foils, including aluminum foil materials, may be used to form the patch antenna elements 111, 112, and 113.

Additionally, while the patch antenna elements 111, 112, and 113 are shown as rectangles or squares in the block diagram of FIG. 3A, it is understood that this is merely representative and the conductive elements associated with the patch antenna elements. Based on the desired field characteristics, the patch antenna elements 111, 112, and 113 may have any shape, such as, for example, circular, square, rectangular, circular ring-shaped, triangular, elliptical, hexagonal, pentagonal, rectangular ring-shaped, or the like. Such shapes would be two-dimensional shapes of the planer surface of the patch antenna elements 111, 112, and 113. According to some example embodiments, a circular or rounded shape may be more readily cut and applied for manufacturing, relative to a rectangular or other non-arcuate shape. According to some example embodiments, the patch antenna elements 111, 112, and 113 may, but need not, have the same shape and size. Size of each patch antenna element may be, for example, about half or a quarter of an operating wavelength for the patch antenna element. The patch antenna elements may be same size or shape, but optimization of antenna and field properties may be completed by tuning each element size and shape separately. As such, different sized patch antenna elements may improve the bandwidth of the overall antenna array or change its near field properties. In this regard, referring now to FIG. 3C, a typical field pattern 190 for a patch antenna is shown. Note that, in a worst case for the patch antenna elements, the gain drops from +9 dBi to −15 dBi at about 90 degrees.

If the patch antenna elements 111, 112, and 113, for example, are circular in shape, the patch antenna elements 111, 112, and 113 may have the same length radius and thus the same surface area. Additionally, as described further below, the positioning of the patch antenna elements 111, 112, and 113 relative to one another may be defined. According to some example embodiments, for symmetric elements, the centers of the patch antenna elements 111, 112, and 113 may be disposed in a line that intersects each of the centers (i.e., the centers are co-linear).

Each of the plurality of feed lines may be formed on the same layer as the patch antenna elements 111, 112, and 113, as described above. According to some example embodiments, the patch antenna elements 111, 112, and 113 and the feed lines may be cut or stamped from a common foil sheet. As such, connections between the patch antenna elements and the feed lines require not soldering or other subsequent connection process. According to some example embodiments, the feed lines 120 and 122 may be electrical connectors between two patch antenna elements. In this regard, as shown in FIG. 3A, feed line 120 physically and electrically connects patch antenna element 111 to patch antenna element 112, and feed line 122 physically and electrically connects patch antenna element 112 to patch antenna element 113.

Since the feed lines 120 and 122 may be cut or stamped form the same foil sheet as the patch antenna elements 111, 112, and 113, the feed lines 120 and 122 may be formed of the same material as the patch antenna elements 111, 112, and 113. According to some example embodiments, the feed lines 120 and 122 may be microstrip lines or microstrip connection elements. Microstrip connection elements may therefore be one example implementation of the feed lines 120 and 122. In this regard, the shape, size, and orientation of the feed lines 120, relative to the patch antenna elements 111, 112, and 113 may be optimized for desire field and radiation characteristics. According to some example embodiments, a length between the patch antenna elements, and thus and effective length of the feed lines 120 and 122 may be about a full operating wavelength. However, in some example embodiments, the length of the feed lines 120 and 122 may be different from the operating wavelength or even each other. For example, the length of the feed lines and thus the impedance of the feed lines may be selected to optimize impedance matching for the patch antenna elements. Due to the materials used and the absence of, for example, soldered connection points, the impedance of feed lines 120 and 122 may be significantly lower than, for example, a more common 50 Ohm feed line, according to some example embodiments. For these reasons, according to some example embodiments, the use of such microstrip feed lines may be superior to the use of wires or cables between the patch antenna elements 111, 112, and 113.

Additionally, to affect the field and radiation characteristics, the feed lines 120 and 122 may approach the patch antenna elements at an angle. Additionally, according to some example embodiments, the feed lines 120 and 122 may include an elongate portion that extends parallel to the line through the centers of the patch antenna elements 111, 112, and 113. According to some example embodiments, the feed lines 120 and 122 may include respective feed line features 121 and 123. Such feed line features may be introduced to change the impedance of the feed lines 120 and 122 and obtain different field or radiation characteristics. For example, the feed line features 121 or 123 may include a single component feedline (e.g., one wide feed line) or multiple component parallel feed lines (e.g., a plurality of parallel narrow feed lines) between two patch antenna elements, or combinations thereof. Additionally or alternatively, the feed line features 121 and 123 may include meander portions, quarter wavelength impedance transformers, discrete components, or the like and combinations thereof to obtain desired radiation and field characteristics.

The isolation layer 140, according to some example embodiments, may be configured to provide an insulating gap between the patch antenna elements 111, 112, and 113 and the ground layer 150. The distance of the gap between the patch antenna elements 111, 112, and 113 and the ground layer 150 can have an effect on the field and radiation characteristics of the antenna array 100. Additionally, because the patch antenna elements 111, 112, and 113 and the ground layer 150 are both formed of conductive materials (e.g., in some instances the same conductive materials such as, for example, aluminum foil material), an insulator is needed between the patch antenna elements 111, 112, and 113 and the ground layer 150. According to some example embodiments, the isolation layer 140 may be an air gap. However, such a configuration may not provide ample structural support to the antenna array 100. As such, according to some example embodiments, an insulating material may be used to form the isolation layer 140. In this regard, for example, the isolation layer 140 may be formed of an insulating foam, such as polystyrene or a polyurethane foam. Such materials may provide structural support to the antenna array 100 and, more particularly to a probe of the feed probe 130 as further described below. Additionally, such materials may have electrical properties that are similar to air.

As mentioned above, the ground layer 150 may be formed of a planar sheet of metal or other conductive material. The ground layer 150 may be disposed in the ground layer plane 151 which may be parallel to the patch plane 115. The ground layer 150 may be shaped such that ground layer 150 is disposed behind at least the patch antenna elements 111, 112, and 113. According to some example embodiments, the ground layer 150 may be shaped such that ground layer 150 is disposed behind the patch antenna elements 111, 112, and 113 and the feed lines 120 and 122.

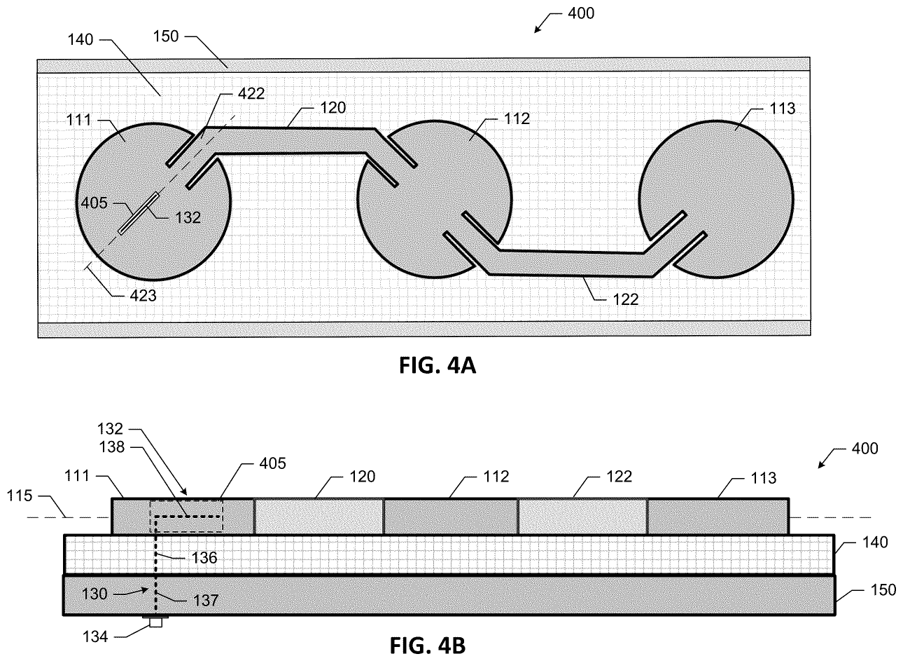

According to some example embodiments, the feed probe 130 may be configured in a variety of ways. The feed probe 130 may be coupled to one of the patch antenna elements 111, 112, and 113 via feed probe interface 132. The patch antenna element that the feed probe 130 is most closely couple to may be referred to as the feed patch antenna element. As shown in FIG. 3A, the patch antenna element 111 is shown as the feed patch antenna element, but it is understood that any patch antenna element may be substituted for the patch antenna element 111 by repositioning or reorienting a probe of the feed probe 130. While the probe of the feed probe 130 could connected via a soldered connection according to some example embodiments, the probe of the feed probe 130 as described with respect to FIGS. 4A to 7B considers the probe to be coupled in an non-physical manner. In this regard, the probe is coupled via induction or a galvanic isolated connection such that there is an insulating gap (e.g., an air gap) between the probe and any conductor that is physically connected to the feed patch antenna element. Such implementations offer less complexity to assemble and wider bandwidth of operation.

Referring now to FIGS. 4A and 4B, an example of the antenna array 100 in the form of an antenna array 400 is shown. The patch antenna elements 111, 112, and 113 are circular in shape and have the same dimensions. As further described below, the patch antenna elements 111, 112, and 113 are aligned such that a line passes through each of the three centers of the patch antenna elements 111, 112, and 113. The feed lines 120 and 122 approach the patch antenna elements 111, 112, and 113, respectively, at rotated 45 degree angles to support the multipolarization of the antenna array 400. The patch antenna elements 111, 112, and 113 and the feed lines 120 and 122 are disposed in the patch plane 115.

The patch antenna element 111, as the feed patch antenna element, includes a slot 405 within the perimeter (or circumference) of the circular shape of the feed patch antenna element. According to some example embodiments, the slot 405 may be elongate with, for example, a rectangular shape. The elongation of the slot 405 may be aligned with a connection portion 422 of the feed line 120 along a direction 423, where the feed line 120 connects to the patch antenna element 111, operating as the feed patch antenna element. As shown in FIG. 4A, as the feed line 120 approaches the patch antenna element 111, the feed line 120 changes direction by about 45 degrees at the connection portion 422 to connect with the patch antenna element 111. The connection portion 422 extends into the circular perimeter of the patch antenna element 111 towards the center of the patch antenna element 111. Notches disposed on both sides of the connection portion 422 to permit the connection portion 422 of the feed line 120 to connect to the patch antenna element 111 at a distance within the circular perimeter of the patch antenna element 111. As such, after the about 45 degree turn of the feed line 120, the connection portion 411 extends along the direction 423, which is the same direction of elongation of the slot 405. The spatial relationships between the feed line 120's connection portion 422 and the elongation of the slot 405 contribute to the field and radiation characteristics of the antenna array 400.

According to some example embodiments, as shown in FIG. 4B, the feed probe 130 may comprise a connector 134 and a probe 136. The connector 134 may be, for example, a coaxial connector that connects to the ground layer 150 at the connector 134 in a manner that is isolated from the probe 136, which extends, for example, for a center of the connector 134. As such, a cable may be connected to the connector 134 to form an isolated electrical connection to the ground layer 150 and the probe 136. The probe 136 may be, for example, a rigid conductor (e.g., copper). In the example embodiment of probe 136, the probe 136 comprises a feed portion 137 and an in-plane portion 138. According to some example embodiments, the feed portion 137 is disposed at a non-zero angle to the in-plane portion 138. In this example embodiment, the feed portion 137 is at about a 90 degree angle to the in-plane portion 138.

As such, to couple to the feed patch antenna element (in this instance patch antenna element 111), the in-plane portion 138 of the probe 136 may be disposed within the slot 405, such that the in-plane portion 138 (or the feed portion 137) does not come into direct contact with the feed patch antenna element. The connector 134 may be disposed on a side of the ground layer 150 opposite the isolation layer 140 to make a convenient connection to the ground layer 150. The feed portion 137 of the probe 136 may extend away from the connector 137 through the ground layer 150 (while being insulated from the ground layer 150 and not in direct contact with the ground layer 150) and through the isolation layer 140. Upon entering the slot 405, the probe 136 turns about ninety degrees and transition to the in-plane portion 138, which extends along the patch plane 115 within the slot 405. Similar to the elongation of the slot 405, the in-plane portion 138 is elongated and extends in the same direction 423 with the slot 405 and the connection portion 422 of the feed line 120.

Because the in-plane portion 138 and the feed portion 137 have about a ninety degree bend between the two, the probe 136 may be referred to as an L-probe. Since the in-plane portion 138 is not in direct contact with the feed patch antenna element, the probe 136 and the feed patch antenna element may rely on induction to transmit signals between the two. In this regard, when a signal is received by the feed patch antenna element, that signal is induced onto the in-plane portion 138 and thus the probe 136. Via the connector 134, the probe 136 is connected to a reader controller, such as reader controller 50, to deliver the received signal to the reader controller. Similarly, to transmit a signal, the in-plane portion 138 may be excited by the application of the a signal to the probe 136 by, for example, the reader controller, and the in-plane portion 138 may induce that signal onto the feed patch antenna element to cause the feed patch antenna element to transmit the signal.

As mentioned above, a benefit of not having a physical connection to the feed patch antenna element is that the connection itself cannot be subjected environment conditions that, over time, may cause the connection (e.g., a solder connection) to fail. Moreover, the absence of a solder or other physical connection reduces the complexity of assembly.

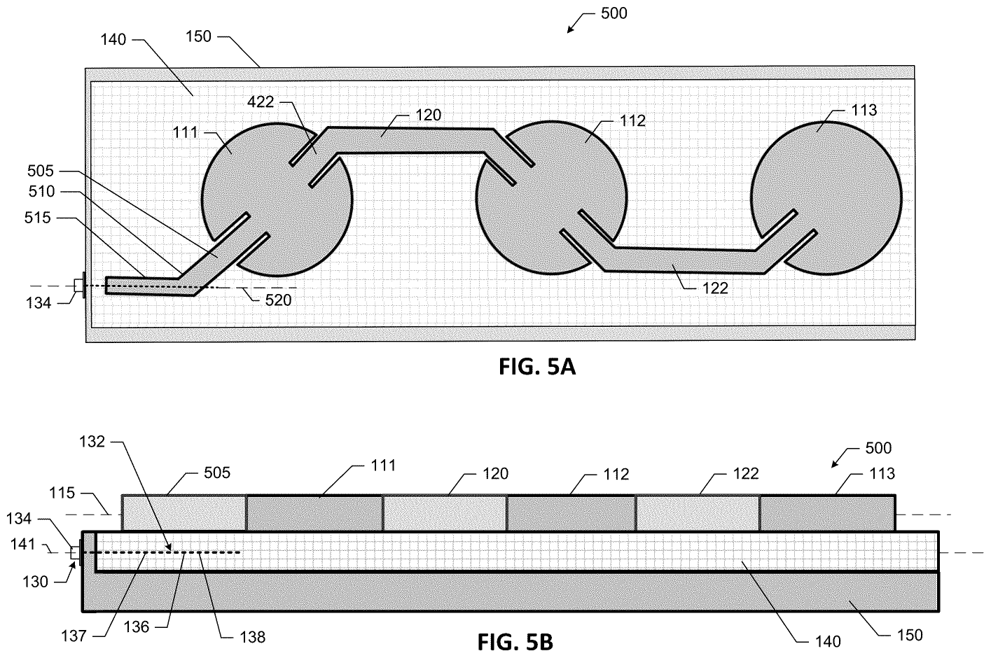

Referring now to FIGS. 5A and 5B, an example of the antenna array 100 in the form of an antenna array 500 is shown. The patch antenna elements 111, 112, and 113 are circular in shape and have the same dimensions. As further described below, the patch antenna elements 111, 112, and 113 are aligned such that a line passes through each of the three centers of the patch antenna elements 111, 112, and 113. The feed lines 120 and 122 approach the patch antenna elements 111, 112, and 113, respectively, at rotated 45 degree angles to support the multipolarization of the antenna array 500. The patch antenna elements 111, 112, and 113 and the feed lines 120 and 122 are disposed in the patch plane 115.

The patch antenna element 111, as the feed patch antenna element is connected to a probe feed line 510 that may be a microstrip probe feed element. The probe feed line 510 may be similar to the feed lines 120 and 122 in structure and composition. As shown in FIG. 5A, the probe feed line 510 may extend away from the feed patch antenna element, patch antenna element 111 in this instance. The probe feed line 510 includes an extension portion 515 that extends away from the connection portion 505. The connection portion 505 is similar to the connection portion 422 in structure, but the connection portion 505 extends away from the patch antenna element 111 on an opposite side of the patch antenna element 111 and in an opposite direction. The connection portion 505 transitions into the extension portion 515 at an about 45 degree turn in the probe feed line 510. After the turn, the extension portion extend linearly for a distance along a direction 520.

In this example embodiment, the feed portion and the in-plane portion 138 are aligned into a linear straight probe for a length of the probe 136. To make the connection between the ground layer 150 and the connector 134, the ground layer 150 may extend around a side of the isolation layer 140 to allow for the connection. The probe 136 may extend into the isolation layer 140 along the isolation layer plane 141. The in-plane portion 138 of the probe 136 may be positioned to align with the extended portion 515 (also referred to as the elongate portion 515) of the probe feed line 510. As such, although in a different plane, the in-plane portion 138 may extend in alignment with the direction 520 of the extended portion 515 of the probe feed line 510. According to some example embodiments, the in-plane portion 138 may extend beyond the 45 turn in the probe feed line 510. The in-line spatial relationship with the extended portion 515 of the probe feed line 510 may operate to increase the inductive coupling between the probe feed line 510 and the probe 136 communicate signals between the two.

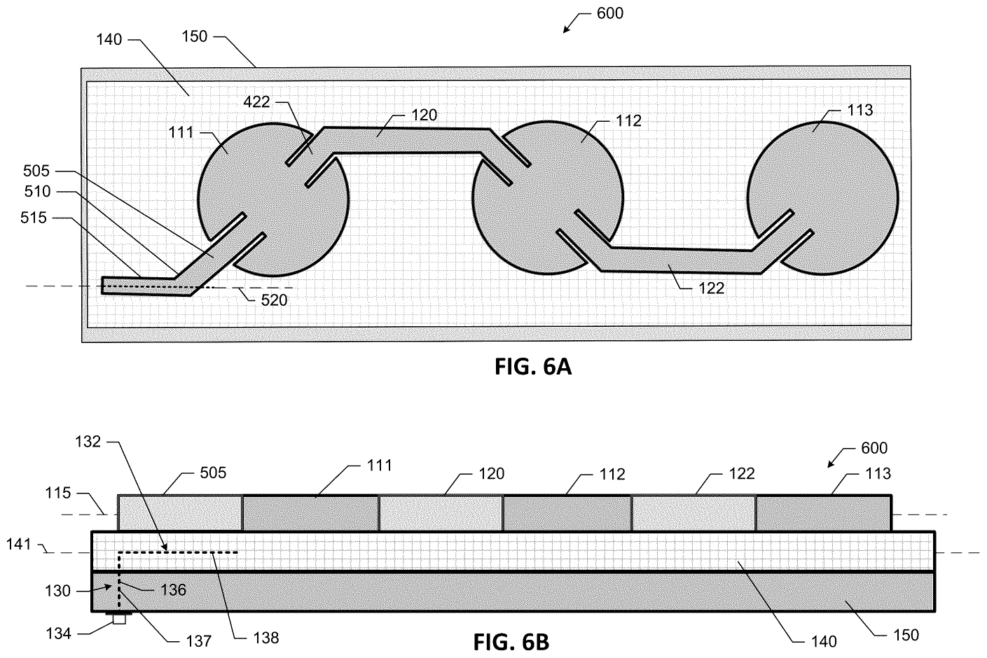

Referring now to FIGS. 6A and 6B, an example of the antenna array 100 in the form of an antenna array 500 is shown. The patch antenna elements 111, 112, and 113 are circular in shape and have the same dimensions. As further described below, the patch antenna elements 111, 112, and 113 are aligned such that a line passes through each of the three centers of the patch antenna elements 111, 112, and 113. The feed lines 120 and 122 approach the patch antenna elements 111, 112, and 113, respectively, at rotated 45 degree angles to support the multipolarization of the antenna array 600. The patch antenna elements 111, 112, and 113 and the feed lines 120 and 122 are disposed in the patch plane 115.

Similar to antenna array 500, the patch antenna element 111, as the feed patch antenna element is connected to a probe feed line 510 that may be a microstrip probe feed element. The probe feed line 510 may be similar to the feed lines 120 and 122 in structure and composition. As shown in FIG. 6A, the probe feed line 510 may extend away from the feed patch antenna element, patch antenna element 111 in this instance. The probe feed line 510 includes an extension portion 515 that extends away from the connection portion 505. The connection portion 505 is similar to the connection portion 422 in structure, but the connection portion 505 extends away from the patch antenna element 111 on an opposite side of the patch antenna element 111 and in an opposite direction. The connection portion 505 transitions into the extension portion 515 at an about 45 degree turn in the probe feed line 510. After the turn, the extension portion extend linearly for a distance along a direction 520.

In this example embodiment, the feed portion 137 and the in-plane portion 138 are not aligned and have a non-zero angle (e.g., a ninety degree angle) between them, similar to the embodiment of FIGS. 4A and 4B. However, rather than being disposed within the slot 405, the in-plane portion 138 of the probe 136 may extend into the isolation layer 140 along the isolation layer plane 141. The in-plane portion 138 of the probe 136 may be positioned to align with the extended portion 515 of the probe feed line 510. As such, although in a different plane, the in-plane portion 138 may extend in alignment with the direction 520 of the extended portion 515 of the probe feed line 510. According to some example embodiments, the in-plane portion 138 may extend beyond the 45 turn in the probe feed line 510. The feed portion 137 may extend towards and through the ground layer 150. The in-line spatial relationship of the in-plane portion 138 with the extended portion 515 of the probe feed line 510 may operate to increase the inductive coupling between the probe feed line 510 and the probe 136 communicate signals between the two.

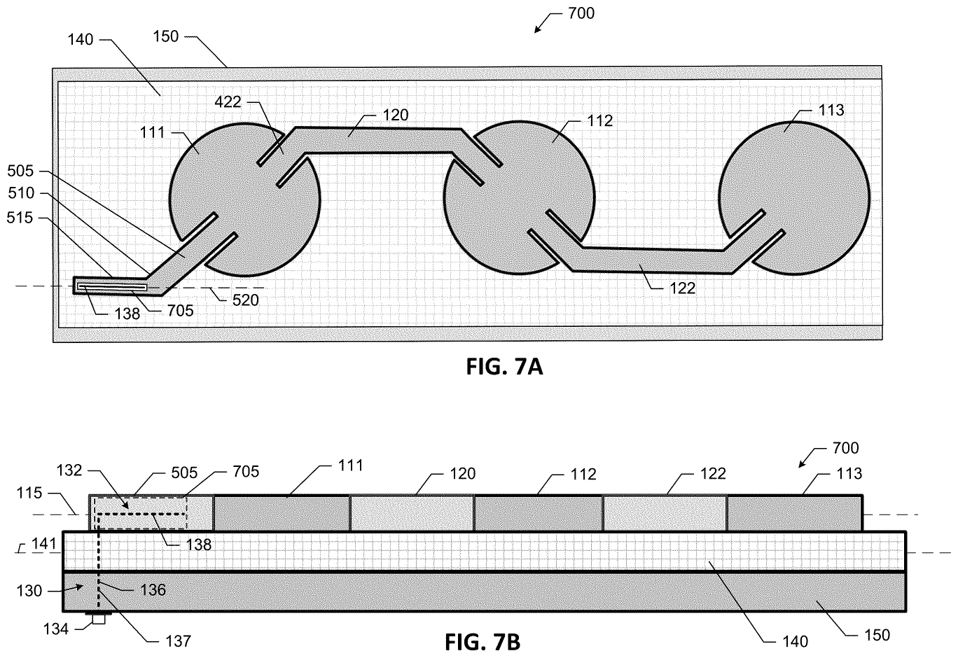

Referring now to FIGS. 7A and 7B, an example of the antenna array 100 in the form of an antenna array 700 is shown. The patch antenna elements 111, 112, and 113 are circular in shape and have the same dimensions. As further described below, the patch antenna elements 111, 112, and 113 are aligned such that a line passes through each of the three centers of the patch antenna elements 111, 112, and 113. The feed lines 120 and 122 approach the patch antenna elements 111, 112, and 113, respectively, at rotated 45 degree angles to support the multipolarization of the antenna array 700. The patch antenna elements 111, 112, and 113 and the feed lines 120 and 122 are disposed in the patch plane 115.

Similar to antenna array 500, the patch antenna element 111, as the feed patch antenna element is connected to a probe feed line 510 that may be a microstrip probe feed element. The probe feed line 510 may be similar to the feed lines 120 and 122 in structure and composition. As shown in FIG. 7A, the probe feed line 510 may extend away from the feed patch antenna element, patch antenna element 111 in this instance. The probe feed line 510 includes an extension portion 515 that extends away from the connection portion 505. The connection portion 505 is similar to the connection portion 422 in structure, but the connection portion 505 extends away from the patch antenna element 111 on an opposite side of the patch antenna element 111 and in an opposite direction. The connection portion 505 transitions into the extended portion 515 at an about 45 degree turn in the probe feed line 510. After the turn, the extension portion extend linearly for a distance along a direction 520.

In this example embodiment, the feed portion 137 and the in-plane portion 138 are not aligned and have a non-zero angle (e.g., a ninety degree angle) between them, similar to the embodiment of FIGS. 4A and 4B. The extended portion 515 of the probe feed line 510 comprises a slot 705. According to some example embodiments, the slot 705 may be elongate with, for example, a rectangular shape. The elongation of the slot 705 may be aligned with the extended portion 705 of the probe feed line 510 along the direction 520. As such, to couple to the feed patch antenna element (in this instance patch antenna element 111), the in-plane portion 138 of the probe 136 may be disposed within the slot 705, such that the in-plane portion 138 (or the feed portion 137) does not come into direct contact with the probe feed line 510 or the feed patch antenna element. Upon entering the slot 705, the probe 136 turns about ninety degrees and transitions to the in-plane portion 138, which extends along the patch plane 115 within the slot 705. Similar to the elongation of the slot 705, the in-plane portion 138 is elongated and extends in the same direction 520 within the slot 705.

As mentioned above, the positioning and configuration of the probe 136 affects the field and radiation characteristics of the antenna array. A variety of parameters can be considered in the design to determine the effect of different configurations. Such parameters include, but are not limited to the length and width of the patch antenna element, the length of the in-plane portion 138, the length of the feed portion 137, and the spacing between the patch antenna element and the ground layer 150.

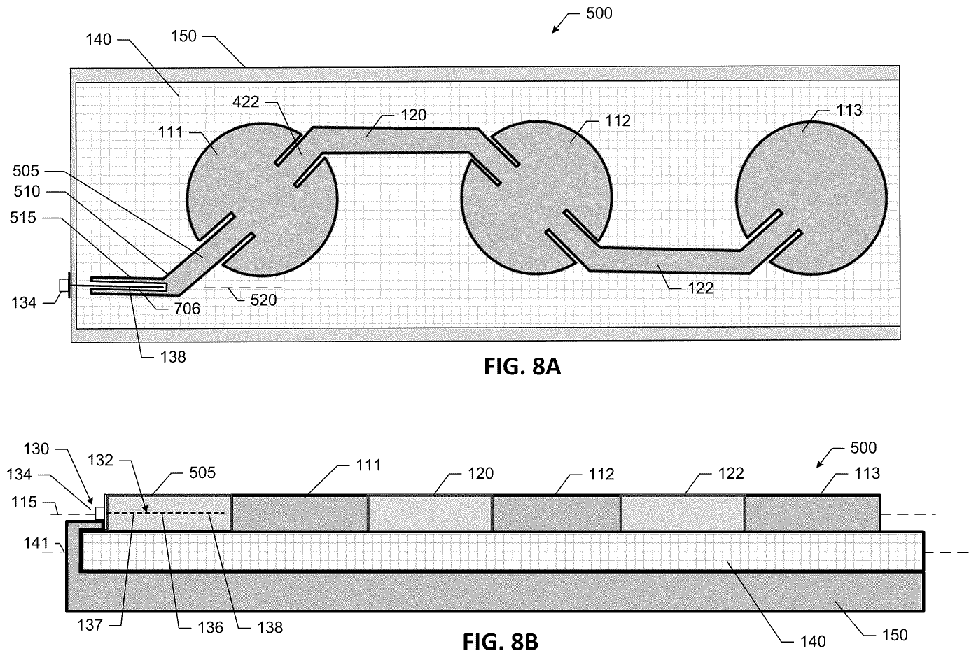

Referring now to FIGS. 8A and 8B, an example of the antenna array 100 in the form of an antenna array 701 is shown. The patch antenna elements 111, 112, and 113 are circular in shape and have the same dimensions. As further described below, the patch antenna elements 111, 112, and 113 are aligned such that a line passes through each of the three centers of the patch antenna elements 111, 112, and 113. The feed lines 120 and 122 approach the patch antenna elements 111, 112, and 113, respectively, at rotated 45 degree angles to support the multipolarization of the antenna array 500. The patch antenna elements 111, 112, and 113 and the feed lines 120 and 122 are disposed in the patch plane 115.

The patch antenna element 111, as the feed patch antenna element is connected to a probe feed line 510 that may be a microstrip probe feed element. The probe feed line 510 may be similar to the feed lines 120 and 122 in structure and composition. As shown in FIG. 8A, the probe feed line 510 may extend away from the feed patch antenna element, patch antenna element 111 in this instance. The probe feed line 510 includes an extension portion 515 that extends away from the connection portion 505. The connection portion 505 is similar to the connection portion 422 in structure, but the connection portion 505 extends away from the patch antenna element 111 on an opposite side of the patch antenna element 111 and in an opposite direction. The connection portion 505 transitions into the extension portion 515 at an about 45 degree turn in the probe feed line 510. After the turn, the extension portion extend linearly for a distance along a direction 520. The extension portion 515 comprises a notch 706 that defines two fingers on either side of the notch 706.

In this example embodiment, the feed portion and the in-plane portion 138 are aligned into a linear straight probe for a length of the probe 136. To make the connection between the ground layer 150 and the connector 134, the ground layer 150 may extend around a side of the isolation layer 140 to allow for the connection. The probe 136 may extend in patch plane 115 and into the notch 706 in the extended portion 515. The in-plane portion 138 of the probe 136 may be positioned to align with the extended portion 515 (also referred to as the elongate portion 515) of the probe feed line 510. As such, the in-plane portion 138 is in the same plane and the patch antenna elements and the in-plane portion may extend within the notch 706 in alignment with the direction 520 of the extended portion 515 of the probe feed line 510. The in-line spatial relationship with the extended portion 515 of the probe feed line 510 may operate to increase the inductive coupling between the probe feed line 510 and the probe 136 communicate signals between the two.

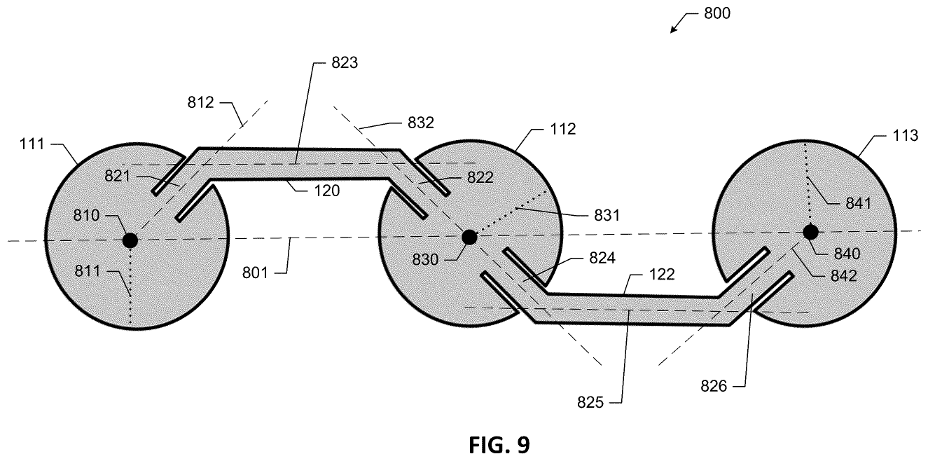

As mentioned above, the orientation of the connection portions of the feed lines 120 and 122 as they approach the patch antenna elements 111, 112, and 113 can have an impact on the field and radiation characteristics of the patch antenna elements and the antenna array. As such, FIG. 9 illustrates another example embodiment of the patch antenna elements 111, 112, and 113 and the feed lines 120 and 122 of the antenna array 100 as assembly 800. The angular relationships of the feed lines 120 and 122 to the patch antenna elements 111, 112, and 113 is therefore described, in according to some example embodiments.

In general, the feed lines 120 and 122 approach the patch antenna elements 111, 112, and 113 at about a 45 degree angle. However, the 45 degree approach angles are different, which can operate to “rotate” the operation of the patch antenna elements and cause differences in polarization.

In this regard, a center line 801 may be defined that passes through the center 810 of the patch antenna element 111, the center 830 of the patch antenna element 112, and the center 840 of the patch antenna element 840. This center line 801 may be a reference line for defining the 45 degree angles of the connection portions of the feed lines. Note initially, that the circular shapes of the patch antenna elements 111, 112, and 113 are defined by the centers 810, 830, and 840 and the respective radii 811, 831, and 841. Since the radii are the same length, the size and shape of the patch antenna elements 111, 112, and 113 are the same. Further, as mentioned above, a spacing between the patch antenna elements 111, 112, and 113 may be a full wavelength.

The connection portion 821 of the feed line 120 extends along a direction 812, where the feed line 120 connects to the patch antenna element 111. As the feed line 120 approaches the patch antenna element 111, the feed line 120 changes direction by about 45 degrees at the connection portion 821 to connect with the patch antenna element 111. The connection portion 821 extends into the circular perimeter of the patch antenna element 111 towards the center of the patch antenna element 111. Notches are disposed on both sides of the connection portion 821 to permit the connection portion 821 of the feed line 120 to connect to the patch antenna element 111 at a distance within the circular perimeter of the patch antenna element 111. As such, after the about 45 degree turn of the feed line 120, the connection portion 821 extends along the direction 812 at about a 45 degree angle to an elongate portion of the feed line 120 that extends along a direction 823 that is parallel to the center line 801. As such, the direction 812 of the connection portion 821 extends at a positive 45 degree angle to the center line 801.

The connection portion 822 of the feed line 120 extends along a direction 832, where the feed line 120 connects to the patch antenna element 112. As the feed line 120 approaches the patch antenna element 112, the feed line 120 changes direction by about 45 degrees at the connection portion 822 to connect with the patch antenna element 112. The connection portion 822 extends into the circular perimeter of the patch antenna element 112 towards the center of the patch antenna element 112. Notches are disposed on both sides of the connection portion 822 to permit the connection portion 822 of the feed line 120 to connect to the patch antenna element 112 at a distance within the circular perimeter of the patch antenna element 112. As such, after the about 45 degree turn of the feed line 120, the connection portion 822 extends along the direction 832 at about a 45 degree angle to an elongate portion of the feed line 120 that extends along a direction 823 that is parallel to the center line 801. As such, the direction 832 of the connection portion 822 extends at a positive 135 degree angle to the center line 801.

The connection portion 824 of the feed line 122 extends along the direction 832, where the feed line 122 connects to the patch antenna element 112. As the feed line 122 approaches the patch antenna element 112, the feed line 122 changes direction by about 45 degrees at the connection portion 824 to connect with the patch antenna element 112. The connection portion 824 extends into the circular perimeter of the patch antenna element 112 towards the center of the patch antenna element 112. Notches are disposed on both sides of the connection portion 824 to permit the connection portion 824 of the feed line 122 to connect to the patch antenna element 112 at a distance within the circular perimeter of the patch antenna element 112. As such, after the about 45 degree turn of the feed line 122, the connection portion 824 extends along the direction 832 at about a 45 degree angle to an elongate portion of the feed line 122 that extends along a direction 825 that is parallel to the center line 801. As such, the direction 832 of the connection portion 824 extends at a negative 45 degree angle to the center line 801.

The connection portion 826 of the feed line 122 extends along the direction 842, where the feed line 122 connects to the patch antenna element 113. As the feed line 122 approaches the patch antenna element 113, the feed line 122 changes direction by about 45 degrees at the connection portion 826 to connect with the patch antenna element 113. The connection portion 826 extends into the circular perimeter of the patch antenna element 113 towards the center of the patch antenna element 113. Notches are disposed on both sides of the connection portion 826 to permit the connection portion 826 of the feed line 122 to connect to the patch antenna element 113 at a distance within the circular perimeter of the patch antenna element 113. As such, after the about 45 degree turn of the feed line 122, the connection portion 826 extends along the direction 842 at about a 45 degree angle to an elongate portion of the feed line 122 that extends along a direction 825 that is parallel to the center line 801. As such, the direction 842 of the connection portion 826 extends at a negative 135 degree angle to the center line 801.

As such, according to some example embodiments, to obtain multiple polarizations, each patch antenna element of the antenna array can be rotated to different angle. For example, the angles can be −45 degree, +45 degree and −45 degree for an example three patch antenna element array. The field generated by each patch antenna element can be summed at the position of a tag that is being read. Depending on the position of the tag, the fields may be destructively or constructively summed. When the tag is moving through the portal passage of a multipolarized antenna array, the tag will move through multiple differently polarized zones due to the spatial interactions between the patch antenna elements.

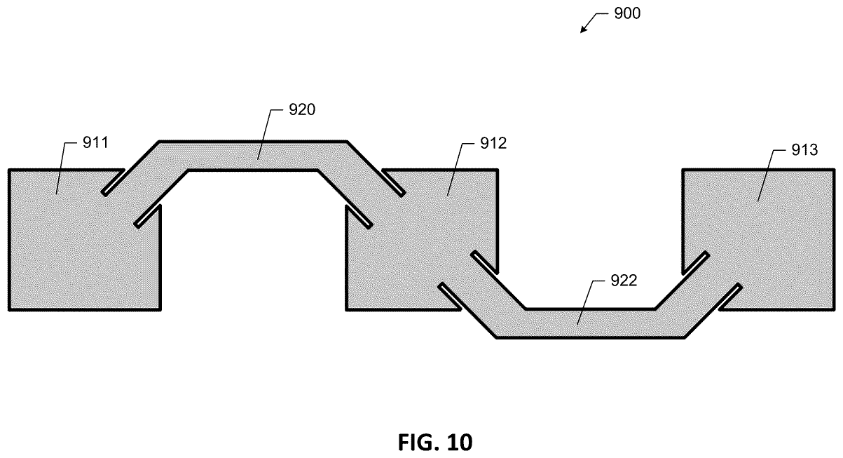

Now, with reference to FIG. 10, an example assembly 900 of patch antenna elements 911, 912, and 913 and feed lines 920 and 922 is shown, which may be a configured used in an example embodiment of the antenna array 100. Rather than being circular, the patch antenna elements 911, 912, and 913 are square. Such a change in the shape of the patch antenna elements would have result in a change in the field and radiation characteristics of the patch antenna elements. As such, the square shaped patch antenna elements may be optimized with respect to shape, size, spacing, feed line configuration, and the like to obtain a desired read region for a reader implementation.

Now referring to FIG. 11, an example implementation of an antenna array 1000 is illustrated according to some example embodiments is shown. The antenna array 1000 may have three patch antenna elements. The antenna array 1000, as a multipolarization antenna array, may generate a field in the z-direction 1001, the x-direction 1002, and the y-direction 1003.

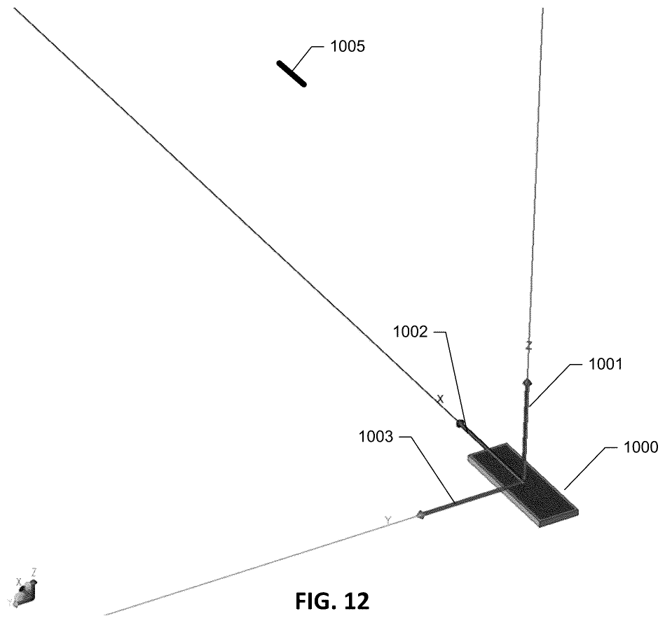

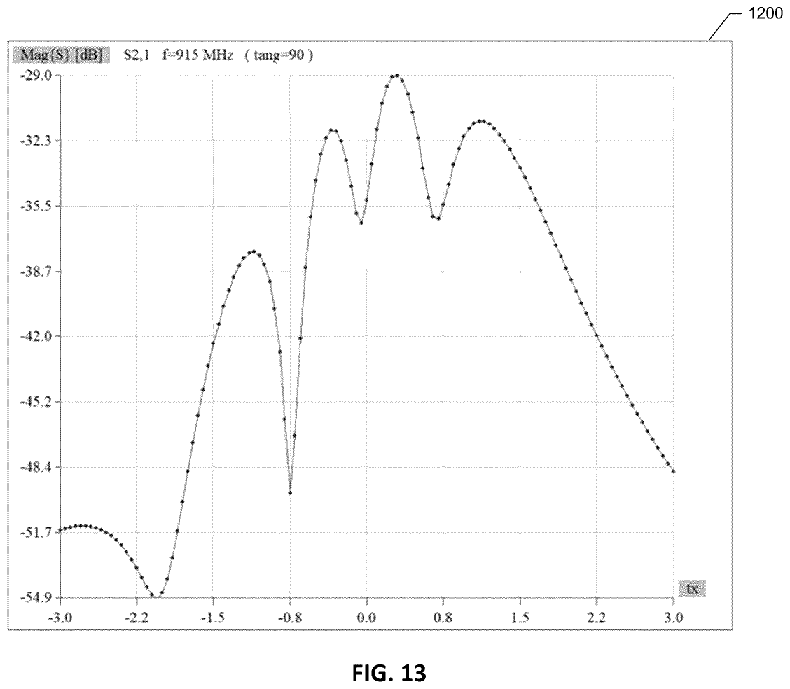

FIG. 12 illustrates test case involving the antenna array 1000, where vertically oriented tag 1005 moves up and down the multipolarized patch antenna array 1000 from a 1.5 meter distance. The tag 1005 may comprise a half wavelength dipole antenna. With the tag 1005 in this vertical orientation and position, the power transfer from antenna array 1000 to tag 1005 is shown in the graph 1200 of FIG. 13. As can be seen, the power transfer curve has multiple notches due to properties of the antenna array 1000.

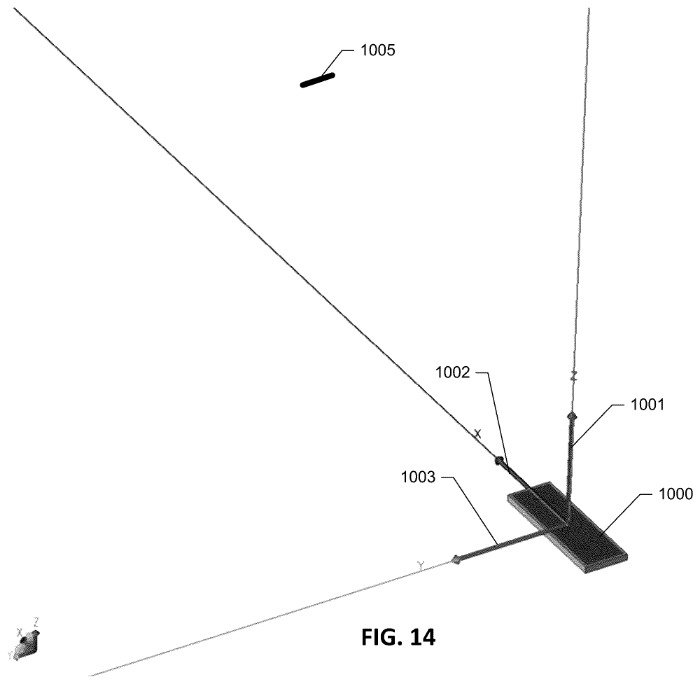

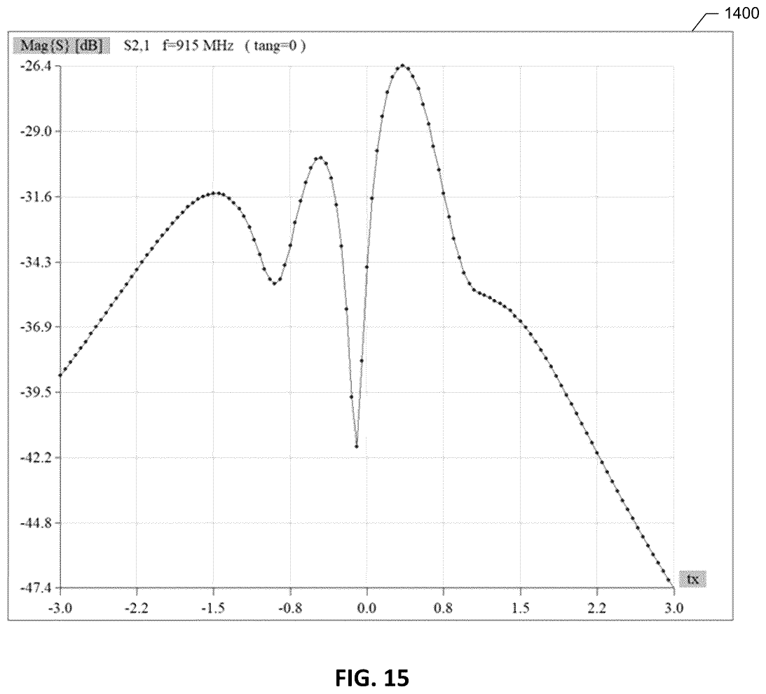

With reference now to FIG. 14, the tag 1005 has rotated 90 degrees into a new orientation. As shown in the graph 1400 of FIG. 15, the power transfer curve is different. The peak value is 3 dB better than in vertical measurement scenario of FIGS. 12 and 13, which is very good for a tag in a random orientation.

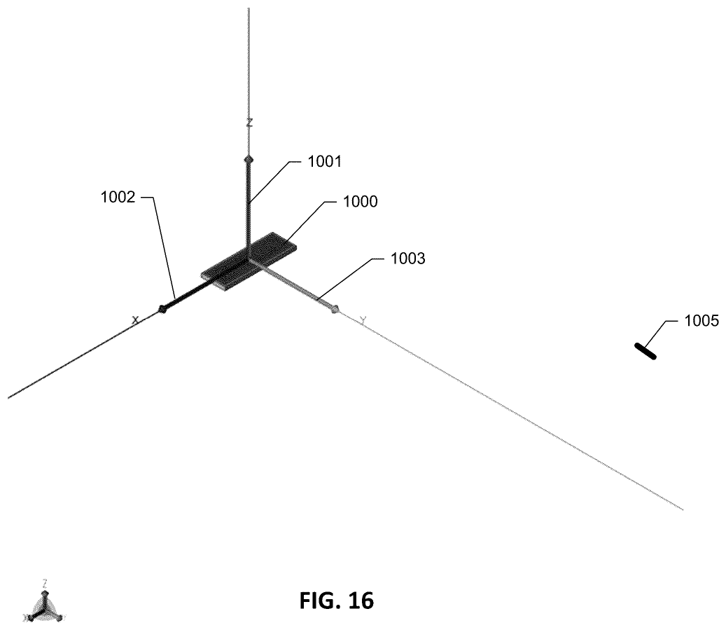

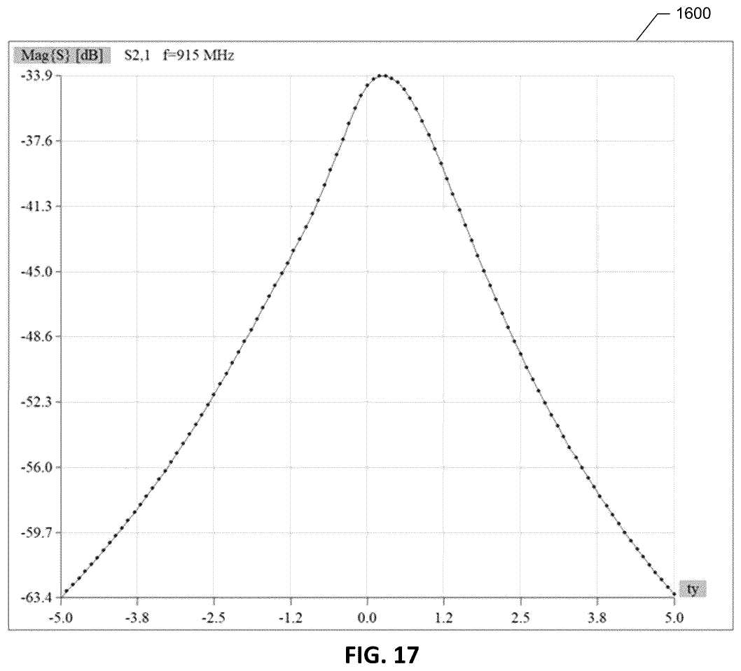

FIG. 16 illustrates the tag 1005 passing the antenna array 1000 along the y-axis and oriented in a horizontal orientation. The graph 1600 of FIG. 17 shows power transfer, which has one peak and no notches, which is a typical response for antenna arrays and supports a fairly narrow reading window to avoid stray reads.

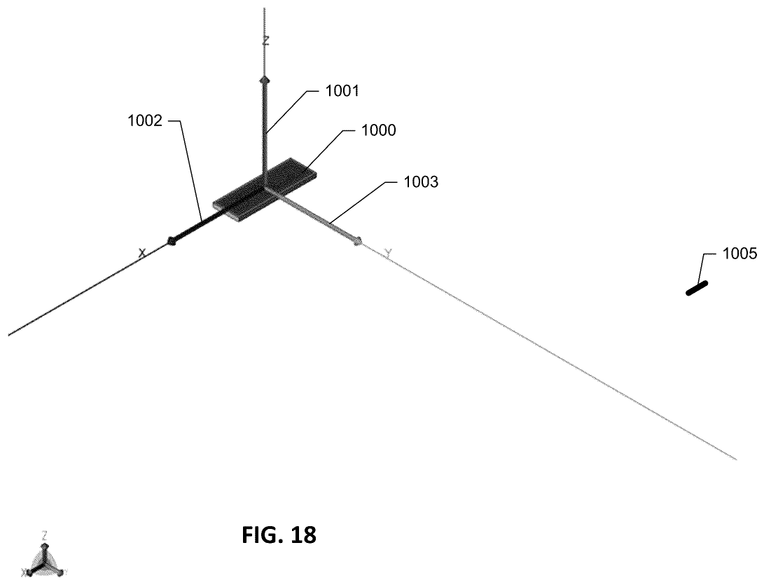

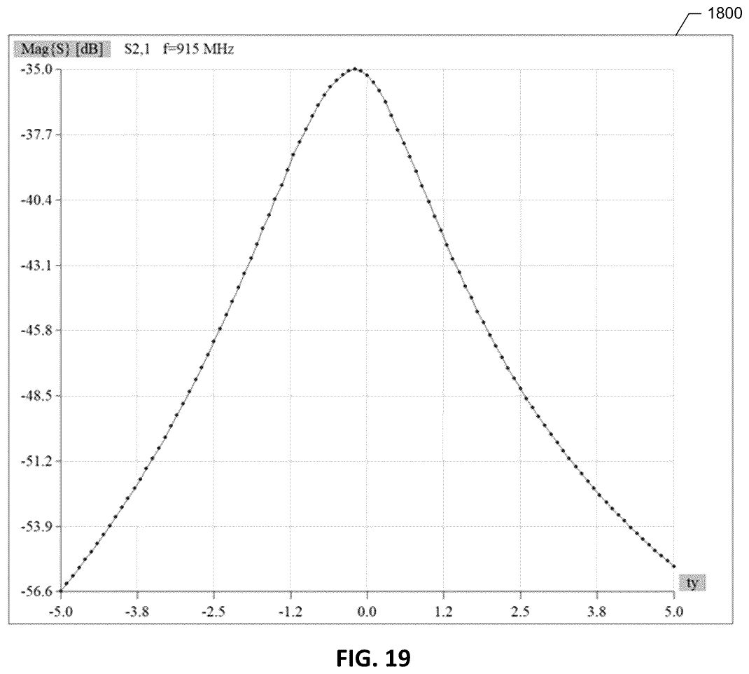

FIG. 18 illustrates the tag 1005 passing the antenna array 1000 along the y-axis and oriented in a vertical orientation. The graph 1800 of FIG. 19 shows that the power transfer is similar to the horizontal orientation. Noted that in the case of horizontal orientation of the tag, the maximum peak is slightly before center line at 0.25 meters, while the maximum for vertical tag orientation occurs after the tag has passed the antenna array 1000 at −0.2 meters.

Having described some example embodiments, the following describes some further example embodiments in accordance with the description above. According to some example embodiments, an antenna array is provided. The antenna array may comprise a plurality of patch antenna elements, a plurality of microstrip connection elements, a probe feed, a ground layer, and an isolation layer. The plurality of patch antenna elements may form multipolarized patch antenna array, and each microstrip connection element may connect two patch antenna elements. The probe feed may be configured to provide a feed point to the antenna array via a galvanic isolated connection to a feed patch antenna element that is one of the plurality of patch antenna elements. The isolation layer may be disposed between the plurality of patch antenna elements and the ground layer.

Additionally, the probe feed may comprise a probe that further comprises an in-plane portion. The in-plane portion may extends within a plane of the feed patch antenna element or a plane parallel to the feed patch antenna element (i.e., a plane of the isolation layer). Additionally, the feed patch antenna may comprise a patch antenna microstrip connection element within a perimeter of the feed patch antenna, and the in-plane portion of the probe feed may be disposed within the patch antenna slot and the in-plane portion may extend along the plane of the feed patch antenna. The probe of the probe feed may comprise a feed portion that extends from the in-plane portion at a non-zero angle such that the feed portion is not within the plane of the feed patch antenna element or the plane parallel to the feed patch antenna element. The non-zero angle may be about ninety degrees. The antenna array may further comprise a microstrip probe feed element connected to and extending from the feed patch antenna element. The probe feed may form the galvanic isolated connection to the feed patch antenna via interaction between the microstrip probe feed element and the in-plane portion of the probe feed. The in-plane portion of the probe feed may be disposed within the plane parallel to the feed patch antenna element and within a plane of the isolation layer, and the in-plane portion of the probe may extend in alignment with an elongate portion of the microstrip probe feed element. The probe of the probe feed may comprise a feed portion that extends from the in-plane portion at a non-zero angle such that the feed portion is not within the plane of the feed patch antenna element or the plane parallel to the feed patch antenna element. The microstrip probe feed element may comprise a microstrip feed slot in an elongate portion of the microstrip feed. The in-plane portion of the probe may be disposed within the microstrip feed slot and the in-plane portion may extend along the plane of the feed patch antenna. The in-plane portion of the probe feed may extend in alignment with the elongate portion of the microstrip probe feed element. The probe feed may comprise a connection to the ground layer and a probe that is not connected to the ground layer. Each of the patch antenna elements may have a circular in shape, a radius of each patch antenna elements may have a same length, and each center of each patch antenna element may be aligned such that the centers are co-linear. Each microstrip connection element may comprise a linear elongate portion and a connection portion. The connection portion may extend away from the linear elongate portion towards a respective patch antenna element at about a forty-five degree angle. The connection portions of microstrip connection elements may define a rotation of a connected patch antenna element to generate a multipolarization characteristic of the antenna array. None of the plurality of patch antenna elements, the plurality of microstrip connection elements, the probe feed configured or the ground layer need be connected to each other via a solder connection. Each patch antenna element may be formed of an aluminum foil material. Each microstrip connection element may have a resistance from end to end of less than 50 ohms. One microstrip connection element of the plurality of microstrip connection elements may comprise a non-linear meander portion, an impedance transformer, or a discrete component configured to affect an impedance of the microstrip connection element and the radiation properties of the antenna array. Each of the plurality of microstrip connection elements may have a shape, wherein the shape is one of circular, square, rectangular, circular ring-shaped, triangular, elliptical, hexagonal, pentagonal, or rectangular ring-shaped.

According to some example embodiments, a tag reader portal is provided. The tag reader portal may comprise a rigid structure, a reader controller, and a plurality of antenna array assemblies. The rigid structure may form a portal passage, and the plurality of antenna array assemblies may be supported by the rigid structure around the portal passage to generate a multipolarized read field within the portal passage. The reader controller may be connected to each of the antenna array assemblies to control the antenna array assemblies and receive tag reader information from the antenna array assemblies. The plurality of antenna array assemblies may comprise an antenna array assembly. The antenna array assembly may comprise a plurality of patch antenna elements, a plurality of microstrip connection elements, a probe feed, a ground layer, and an isolation layer. The plurality of patch antenna element may form multipolarized patch antenna array, and each microstrip connection element may connect two patch antenna elements. The probe feed may be configured to provide a feed point to the antenna array via a galvanic isolated connection to a feed patch antenna element that is one of the plurality of patch antenna elements. The isolation layer may be disposed between the plurality of patch antenna elements and the ground layer.

Many modifications and other example embodiments in addition to those set forth herein will come to mind to one skilled in the art to which these embodiments pertain having the benefit of the teachings presented in the foregoing descriptions and the associated drawings. Therefore, it is to be understood that the embodiments are not to be limited to those disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed is:

1. An antenna array comprising:
a plurality of patch antenna elements, the plurality of patch antenna elements forming multipolarized patch antenna array;
a plurality of microstrip connection elements, each microstrip connection element connecting two patch antenna elements;
a probe feed configured to provide a feed point to the antenna array via a galvanic isolated connection to a feed patch antenna element, the feed patch antenna element being one of the plurality of patch antenna elements;
a ground layer; and
an isolation layer disposed between the plurality of patch antenna elements and the ground layer.

2. The antenna array of claim 1, wherein the probe feed comprises a probe that further comprises an in-plane portion;
wherein the in-plane portion extends within a plane of the feed patch antenna element or a plane parallel to the feed patch antenna element.

3. The antenna array of claim 2, wherein the feed patch antenna comprises a patch antenna microstrip connection element within a perimeter of the feed patch antenna;
wherein the in-plane portion of the probe feed is disposed within the patch antenna slot and the in-plane portion extends along the plane of the feed patch antenna.

4. The antenna element of claim 3, wherein the probe of the probe feed comprises a feed portion that extends from the in-plane portion at a non-zero angle such that the feed portion is not within the plane of the feed patch antenna element or the plane parallel to the feed patch antenna element.

5. The antenna element of claim 4, wherein the non-zero angle is about ninety degrees.

6. The antenna array of claim 2 further comprising a microstrip probe feed element connected to and extending from the feed patch antenna element;
wherein the probe feed forms the galvanic isolated connection to the feed patch antenna via interaction between the microstrip probe feed element and the in-plane portion of the probe feed.

7. The antenna array of claim 6, wherein the in-plane portion of the probe feed is disposed within the plane parallel to the feed patch antenna element and within a plane of the isolation layer;
wherein the in-plane portion of the probe extends in alignment with an elongate portion of the microstrip probe feed element.

8. The antenna element of claim 7, wherein the probe of the probe feed comprises a feed portion that extends from the in-plane portion at a non-zero angle such that the feed portion is not within the plane of the feed patch antenna element or the plane parallel to the feed patch antenna element.

9. The antenna array of claim 4, wherein the microstrip probe feed element comprises a microstrip feed slot in an elongate portion of the microstrip feed;
wherein the in-plane portion of the probe is disposed within the microstrip feed slot and the in-plane portion extends along the plane of the feed patch antenna;
wherein the in-plane portion of the probe feed extends in alignment with the elongate portion of the microstrip probe feed element.

10. The antenna array of claim 1, wherein the probe feed comprises a connection to the ground layer and a probe that is not connected to the ground layer.

11. The antenna array of claim 1, wherein each of the patch antenna elements have a circular in shape;
wherein a radius of each patch antenna elements has a same length;
wherein each center of each patch antenna element is aligned such that the centers are co-linear.

12. The antenna array of claim 1, wherein each microstrip connection element comprises a linear elongate portion and a connection portion;
wherein the connection portion extends away from the linear elongate portion towards a respective patch antenna element at about a forty-five degree angle.

13. The antenna array of claim 12, wherein the connection portions of microstrip connection elements define a rotation of a connected patch antenna element to generate a multipolarization characteristic of the antenna array.

14. The antenna array of claim 1, wherein none of the plurality of patch antenna elements, the plurality of microstrip connection elements, the probe feed configured or the ground layer are connected to each other via a solder connection.

15. The antenna array of claim 1, wherein each patch antenna element is formed of an aluminum foil material.

16. The antenna array of claim 1, wherein each microstrip connection element has a resistance from end to end of less than 50 ohms.

17. The antenna array of claim 1, wherein one microstrip connection element of the plurality of microstrip connection elements comprises a non-linear meander portion, an impedance transformer, or a discrete component configured to affect an impedance of the microstrip connection element and the radiation properties of the antenna array.

18. The antenna array of claim 1, wherein each of the plurality of microstrip connection elements has a shape, wherein the shape is one of circular, square, rectangular, circular ring-shaped, triangular, elliptical, hexagonal, pentagonal, or rectangular ring-shaped.

19. A tag reader portal comprising:
a rigid structure forming a portal passage;
a reader controller; and
a plurality of antenna array assemblies supported by the rigid structure around the portal passage to generate a multipolarized read field within the portal passage, the reader controller being connected to each of the antenna array assemblies to control the antenna array assemblies and receive tag reader information from the antenna array assemblies;
wherein the plurality of antenna array assemblies comprises an antenna array assembly;
wherein the antenna array assembly comprises:
a plurality of patch antenna elements, the plurality of patch antenna elements forming multipolarized patch antenna array;
a plurality of microstrip connection elements, each microstrip connection element connecting two patch antenna elements;
a probe feed configured to provide a feed point to the antenna array via a galvanic isolated connection to a feed patch antenna element, the feed patch antenna element being one of the plurality of patch antenna elements;
a ground layer; and
an isolation layer disposed between the plurality of patch antenna elements and the ground layer.

20. The tag reader portal of claim 19, wherein the probe feed comprises a probe that further comprises an in-plane portion;
wherein the in-plane portion extends within a plane of the feed patch antenna element or a plane parallel to the feed patch antenna element.
